(19) United States
(12) Patent Application Publication
(10) Pub. No.: US 2013/0103970 A1
(43) Pub. Date: Apr. 25, 2013

(54) NETWORK DEVICE, NETWORK NOTIFYING DEVICE APPLIED TO NETWORK DEVICE AND ASSOCIATED NETWORK NOTIFYING METHOD

(71) Applicants: Chung-Wen Tang, Miaoli County (TW); Liang-Wei Huang, Hsinchu City (TW); Li-Han Liang, Taipei City (TW); Ta-Chin Tseng, New Taipei City (TW)

(72) Inventors: Chung-Wen Tang, Miaoli County (TW); Liang-Wei Huang, Hsinchu City (TW); Li-Han Liang, Taipei City (TW); Ta-Chin Tseng, New Taipei City (TW)

(21) Appl. No.: 13/607,833

(22) Filed: Sep. 10, 2012

(30) Foreign Application Priority Data
Oct. 21, 2011 (TW) 100138393

(51) Int. Cl. G06F 1/04

(52) U.S. Cl. 713/502

(57) ABSTRACT

A network notifying device applied to a first network device is provided, where the first network device is coupled to a second network device, and the network notifying device includes an interface control circuit, a clock generator and a counter. The interface control circuit is coupled to the second network device, and stores a notify command. The clock generator is utilized for generating a clock signal. The counter is coupled to the interface control circuit and the clock generator, and the counter counts the clock signal to periodically generate a trigger signal to the interface control circuit to trigger the interface control circuit to transmit the notify signal to the second network device. In addition, operations of the clock generator and the counter are independent from a processor of the first network device.

### BACKGROUND OF THE INVENTION

1. Field of the Invention

The present invention relates to a network device, and more particularly, to a network notifying device applied to a network device and associated network notifying method.

2. Description of the Prior Art

In Ethernet standard, a network device has a function “Wake On Lan” to receive packets from a network line when the system enters a sleep mode (i.e., a portion of circuits of the system is still operated), and to determine whether to wake up a whole system. In addition, in high definition multimedia interface (HDMI) version 1.4, when a network device enters the sleep mode, the network device needs to periodically transmit a notify command to a far-end network device. In light of above, because the network device needs to perform some operations when the network device is operated under the sleep mode, how to minimize a power consumption of the network device during the sleep mode is an important topic.

### SUMMARY OF THE INVENTION

It is therefore an objective of the present invention to provide a network notifying device applied to a network device and associated network notifying method, which can make the network device have lower power consumption during a sleep mode, to solve the above-mentioned problem.

According to one embodiment, a network notifying device applied to a first network device is disclosed, where the first network device is coupled to a second network device, and the network notifying device comprises an interface control circuit, a clock generator and a counter. The interface control circuit is coupled to the second network device, and stores a notify command. The clock generator is utilized for generating a clock signal. The counter is coupled to the interface control circuit and the clock generator, and the counter counts the clock signal to periodically generate a trigger signal to the interface control circuit to trigger the interface control circuit to transmit the notify signal to the second network device. In addition, operations of the clock generator and the counter are independent from a processor of the first network device.

According to another embodiment of the present invention, a network device is disclosed, where the network device is coupled to another network device, the network device includes a processor and a network notifying device, and the network notifying device comprises an interface control circuit, a clock generator and a counter. The interface control circuit is coupled to the other network device, and stores a notify command. The clock generator is utilized for generating a clock signal. The counter is coupled to the interface control circuit and the clock generator, and the counter counts the clock signal to periodically generate a trigger signal to the interface control circuit to trigger the interface control circuit to transmit the notify signal to the other network device. In addition, operations of the clock generator and the counter are independent from a processor of the first network device.

According to another embodiment of the present invention, a network notifying method applied to a first network device is disclosed, where the first network device is coupled to a second network device, and the network notifying method comprises: storing a notifying command; generating a clock signal; and counting the clock signal to periodically generate a trigger signal to trigger transmitting the notify signal to the second network device, where the clock signal is different from a system clock used by a processor of the first network device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first network device according to one embodiment of the present invention.

FIG. 2 is a diagram illustrating a network notifying device according to one embodiment of the present invention.

FIG. 3 is a flowchart of a network notifying method applied to a first network device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

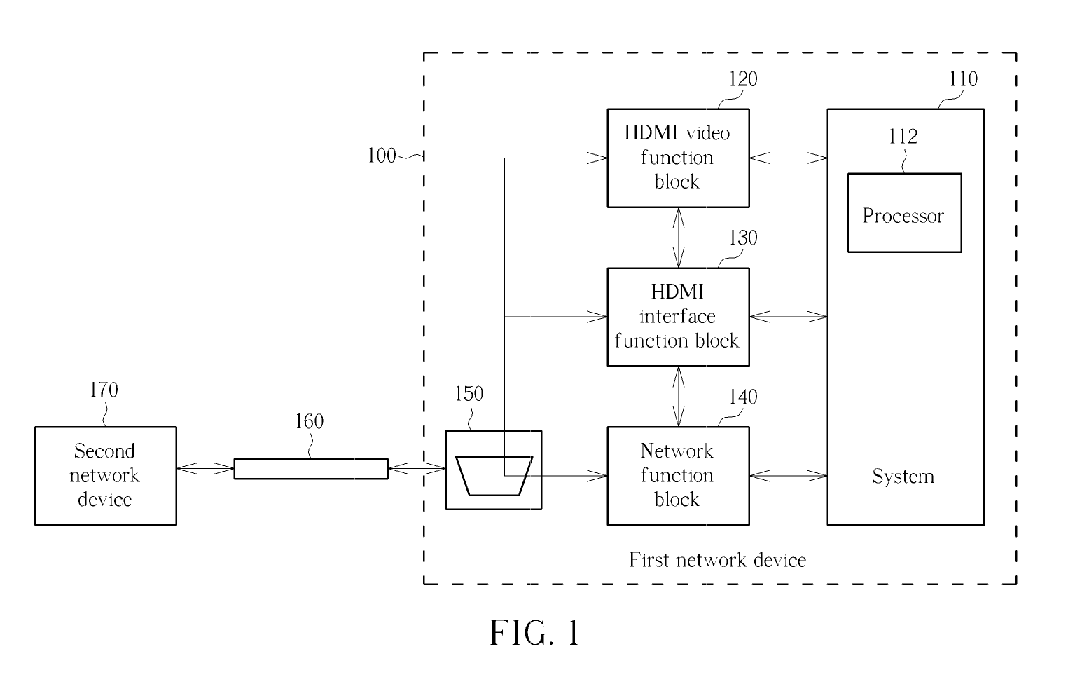

Please refer to FIG. 1, which is a diagram illustrating a first network device 100 according to one embodiment of the present invention. As shown in FIG. 1, the first network device 100 includes a system 110, a HDMI video function block 120, a HDMI interface function block 130, a network function block 140 and a HDMI connector 150, where the system 110 includes at least a processor 112, and the first network device 100 is coupled to a second network device 170 via a HDMI transmission line 160. In addition, in this embodiment, the first network device 100 is complied with HDMI version 1.4, but it is not meant to be a limitation of the present invention.

In the operations of the first network device 100, the HDMI video function block 120 is used to transmit video data to the second network device 170, the HDMI interface function block 130 is used to transmit interface data such as display data channel (DDC) data and consumer electronics control (CEC) data, the network function block 140 is used to perform network operations. In addition, in one embodiment, the HDMI video function block 120, the HDMI interface function block 130 and the network function block 140 can be integrated into a single chip, and each function block is communicated with the other function blocks via internal buses. In addition, if the HDMI video function block 120 and the network function block 140 are built in different chips, each of the chips has an interface function block, and the chips are communicated with each other by using the CEC messages.

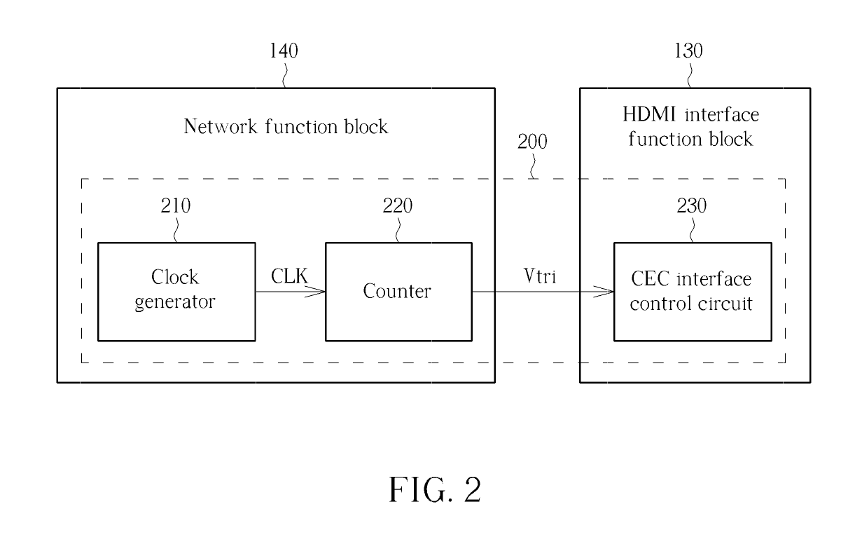

Please refer to FIG. 2, which is a diagram illustrating a network notifying device 200 according to one embodiment of the present invention. As shown in FIG. 2, the network notifying device 200 is a portion of circuits of the HDMI interface function block 130 and the network function block 140, and the network notifying device 200 includes a clock generator 210, a counter 220 and a CEC interface control circuit 230. In addition, in this embodiment, the clock generator 210 is a digital controlled oscillator (DCO) and the counter 220 is a ripple counter, but it is not meant to be a limitation of the present invention.

In the operations of the first network device 100 and the network notifying device 200, after the first network device 100 establishes a network connection with the second network device 170, the first network device 100 gets a physical address via the DDC function of the HDMI interface function block 130, and the first network device 100 gets a capability discovery and control (CDC) protocol with the second network device 170. Then, after a HDMI Ethernet channel (HEC) is enabled, the network function block 140 can start to transmit and receive network packets via the Ethernet channel. At this time, a notify command (NotifyAlive) is stored into the CEC interface control circuit 230, and the counter 220 is enabled. The counter 220 continuously counts a clock signal CLK generated from the clock generator 210 to periodically generate a trigger signal Vtri to the CEC interface control circuit 230 (a period of the trigger signal Vtri is about 60-65 seconds) to trigger the CEC interface control circuit 230 to transmit the notify command (NotifyAlive) to the second network device 170.

In this embodiment, the operations of the clock generator 210 and the counter 220 are independent from the processor 112 of the system 110, and the clock signal CLK generated from the clock generator 210 is different from a system clock of the processor 112. Therefore, when the processor 112 of the first network device 100 is operated under a sleep mode, the processor 112 and other circuits that is not required to be operated of the system 100 can be idled or powered off to decrease the static power consumption, and at least a portion of the system clocks can also be disabled to decrease the dynamic power consumption. When the processor 122 is operated under the sleep mode, a portion of the circuits of the network function block 140 maintain operating to receive the packets from the HDMI transmission line 160 to determine whether to wake up the whole system, and the network notifying device 200 still performs the normal operation to periodically transmit the notify command (NotifyAlive) to the second network device 170 to make the HEC function of the first network device 100 in an active status.

In light of above, because the operations of the network notifying device 200 are independent from the processor 112 of the system 110, the processor 112 does not need to perform any operation during the sleep mode, and the power consumption is lowered.

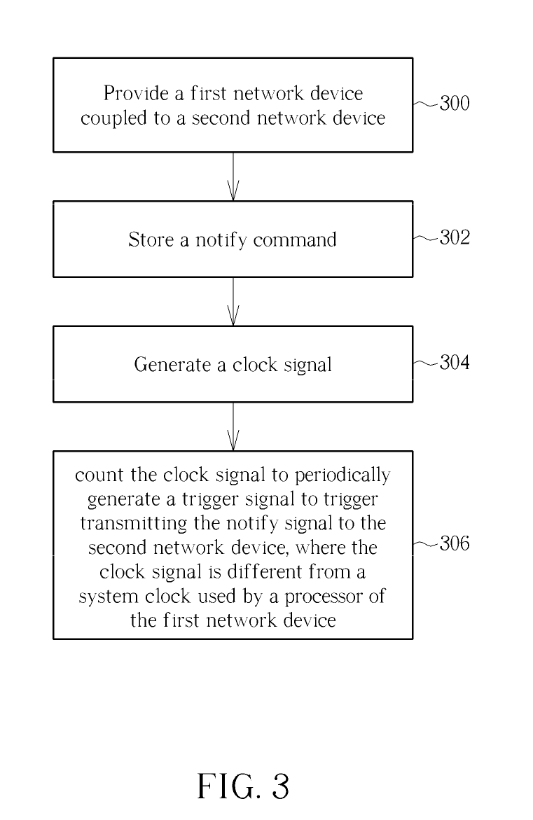

Please refer to FIG. 3, which is a flowchart of a network notifying method applied to a first network device according to one embodiment of the present invention. Referring to FIGS. 1-3, the flow is described as follows.

Step 300: provide a first network device coupled to a second network device;

Step 302: store a notify command;

Step 304: generate a clock signal;

Step 306: count the clock signal to periodically generate a trigger signal to trigger transmitting the notify signal to the second network device, where the clock signal is different from a system clock used by a processor of the first network device.

Briefly summarized, in the network notifying device and the network notifying method of the present invention, when the network device enters a sleep mode, the network function of the network device can be maintained in an active status under a condition that a processor and a system clock of the network device are powered off. Therefore, the power consumption of the network device is indeed lowered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network notifying device applied to a first network device, wherein the first network device is coupled to a second network device, and the network notifying device comprises:
an interface control circuit, coupled to the second network device, wherein the interface control circuit stores a notify command;
a clock generator, for generating a clock signal; and
a counter, coupled to the interface control circuit and the clock generator, for counting the clock signal to periodically generate a trigger signal to the interface control circuit to trigger the interface control circuit to transmit the notify command to the second network device;
wherein operations of the clock generator and the counter are independent from a processor of the first network device.

2. The network notifying device of claim 1, wherein when the processor of the first network device is operated under a sleep mode, the network notifying device still periodically transmits the notify command to the second network device.

3. The network notifying device of claim 1, wherein the clock signal is different from a system clock used by the processor of the first network device.

4. The network notifying device of claim 1, wherein the clock generator is a digital controlled oscillator.

5. The network notifying device of claim 1, wherein the counter is a ripple counter.

6. The network notifying device of claim 1, wherein the first network device is complied with high definition multimedia interface (HDMI) standard.

7. A network device, wherein the network device is coupled to another network device, and the network device comprises:
a processor; and
a network notifying device, comprising:
an interface control circuit, coupled to the other network device, wherein the interface control circuit stores a notify command;
a clock generator, for generating a clock signal; and
a counter, coupled to the interface control circuit and the clock generator, for counting the clock signal to periodically generate a trigger signal to the interface control circuit to trigger the interface control circuit to transmit the notify command to the other network device;
wherein operations of the clock generator and the counter are independent from the processor.

8. The network device of claim 7, wherein when the processor is operated under a sleep mode, the processor does not perform any operation.

9. The network device of claim 7, wherein when the processor is operated under a sleep mode, at least a portion of system clocks of the network device is disabled.

10. The network device of claim 7, complied with high definition multimedia interface (HDMI) standard.

11. A network notifying method applied to a first network device, wherein the first network device is coupled to a second network device, and the network notifying method comprises:
storing a notifying command;
generating a clock signal; and
counting the clock signal to periodically generate a trigger signal to trigger transmitting the notify signal to the second network device;
wherein the clock signal is different from a system clock used by a processor of the first network device.

12. The network notifying method of claim 11, further comprising:
when the processor of the network device is operated under a sleep mode, disabling the processor.

13. The network notifying method of claim 11, further comprising:
when the processor of the network device is operated under a sleep mode, disabling at least a portion of system clocks of the network device.

14. The network notifying method of claim 11, wherein the first network device is complied with high definition multimedia interface (HDMI) standard.
